(19) United States
(12) Patent Application Publication
(10) Pub. No.: US 2022/0209550 A1
(43) Pub. Date: Jun. 30, 2022

(54) Redundant power distribution and monitoring for LTA vehicles

(71) Applicant: LOON LLC, Mountain View, CA (US)

(72) Inventors: Ewout van Bekkum, Sunnyvale, CA (US); Jonathan Nutzmann, Redwood City, CA (US)

(73) Assignee: LOON LLC, Mountain View, CA (US)

(21) Appl. No.: 17/137,920

(22) Filed: Dec. 30, 2020

(51) Int. Cl. H02J 7/00; F03D 9/00; H02J 11/00; B64B 1/40; F03D 9/32

(52) U.S. Cl. CPC H02J 7/0024; F03D 9/007; F03D 9/32; B64B 1/40; H02J 11/00

(57) ABSTRACT

The technology relates to techniques for redundant power distribution and monitoring for lighter than air (LTA) vehicles. A power distribution and monitoring system for an LTA vehicle, can include two or more redundant controllers coupled to a multiplexer in a crossbar architecture. Each controller can control the multiplexer and inhibit the other controller in the case of a failure of the other controller. Each controller can control a power switch to direct power from a power source to an electronic component, and can monitor the power source. In some cases, a first controller receives a signal indicting a failure in a second controller, and the first controller inhibits the second controller and directs power from the power source to the electronic component.

### BACKGROUND OF INVENTION

Fleets of lighter than air (LTA) aerial vehicles are being considered for a variety of purposes, including providing data and network connectivity, data gathering (e.g., image capture, weather and other environmental data, telemetry), and systems testing, among others. LTA vehicles can utilize a balloon envelope, a rigid hull, or a non-rigid hull filled with a gas mixture that is lighter than air to provide lift. The gas that is lighter than air within the envelope displaces the heavier air, thereby providing buoyancy to the LTA vehicle. Some LTA vehicles are propelled in a direction of flight using propellers driven by engines or motors and utilize fins to stabilize the LTA vehicle in flight.

LTA vehicles can have a single controller (e.g., a flight controller) controlling an electrical system onboard the LTA vehicle. For example, a central power distribution node and power monitoring system for an LTA vehicle is typically controlled using a single controller. Power distribution and monitoring systems for LTA vehicles can contain various power sources, such as batteries and solar panels. The power from the sources is distributed to different electrical components of the vehicle. In some cases, an LTA vehicle can use multiple power sources, such as multiple batteries or solar panels, and the parameters of the power sources are monitored by the single controller. In some cases, a power distribution and monitoring system can contain an avionics communication bus between the single controller and the system that is segmented between different physical layer (PHY) transports.

Command and control systems for LTA vehicles are also typically controlled using a single controller. The command and control system can be used to operate various systems and components of the LTA vehicle, for example, a system to control the altitude of the LTA vehicle, a propulsion system, navigation components (e.g., to control the pitch, roll, and yaw of the LTA vehicle), and communications systems (e.g., to communicate between the LTA vehicle and an offboard system). The command and control system can receive commands from offboard the LTA vehicle (e.g., from an operator on the ground), or can operate autonomously without receiving commands from offboard the LTA vehicle.

LTA vehicles with a single controller controlling systems of the LTA vehicle are vulnerable if the single controller fails (e.g., becomes compromised, damaged or unable to communicate with other systems, for example the memory becomes corrupted or there is a hardware fault). For example, systems where the avionics communication buses are segmented between different physical layer (PHY) transports can suffer from a single point of failure for monitoring power systems.

### BRIEF SUMMARY

The present disclosure provides techniques for redundant power distribution and monitoring for lighter than air (LTA) vehicles. A power distribution and monitoring system for a lighter than air vehicle, can include: two or more redundant controllers coupled to a multiplexer in a crossbar architecture, wherein each controller is configured to control the multiplexer and to inhibit the other controller in the case of a failure of the other controller; a shared subsystem coupled to the multiplexer, the shared subsystem comprising a power switch; a power source coupled to the shared subsystem; and an electronic component coupled to the shared subsystem, wherein each of the two or more redundant controllers is further configured to control the power switch to direct power from the power source to the electronic component, wherein each of the two or more redundant controllers is further configured to monitor the power source. In an example, the power distribution and monitoring system above, further includes two or more select switches that are coupled to the two or more redundant controllers and to the multiplexer, wherein the crossbar architecture comprises two or more control interface connections between each of the two or more redundant controllers and the multiplexer, two or more control multiplexer select connections between each of the two or more redundant controllers and the multiplexer, and two or more inhibiting connections between each of the two or more redundant controllers and two or more select switches. In another example, one of the two or more control multiplexer select connections is output from each of the two or more redundant controllers and input into one of the two or more select switches, and one of the two or more control multiplexer select connections is output from each of the two or more select switches and input into the multiplexer. In another example, the two or more redundant controllers comprise a first and a second controller, and wherein the crossbar architecture further comprises: a first control interface connection coupling the first controller to the multiplexer and a second control interface connection coupling the second controller to the multiplexer; a first control multiplexer select connection coupling the first controller to a first select switch and a second control multiplexer select connection coupling the second controller to a second select switch; a third control multiplexer select connection coupling the first select switch to the multiplexer and a fourth control multiplexer select connection coupling the second select switch to the multiplexer; and a first inhibiting connection coupling the first controller to the second select switch and a second inhibiting connection coupling the second controller to the first select switch. In another example, the two redundant controllers are located in the same physical enclosure and are electrically isolated from one another. In another example, the power source comprises one or more of a battery, a fuel cell, a solar panel, and rotors configured to be spun by wind to generate energy. In another example, the two or more redundant controllers is further configured to monitor one or more parameters of the power source, wherein the one or more parameters of the power source comprise one or more of a temperature, a charge imbalance, a fault, a voltage, a current, charge accumulation, energy accumulation, a current state of charge, efficiency, shading, and parasitic power monitoring. In another example, the electronic component comprises one or more of a flight computer, a communications component, an altitude control system component, a navigation system component, and a sensor. In another example, the power distribution and monitoring system above, further includes a communications system coupled to the two redundant controllers, wherein the communications system comprises two or more communications units, each communications unit coupled to one of the two or more redundant controllers. In another example, the power distribution and monitoring system above, further includes a communications system coupled to the two or more redundant controllers, wherein the communications system is shared by the two or more redundant controllers. In another example, the shared subsystem further comprises a communications system, and wherein the two or more redundant controllers control the communications system.

A method for controlling a power distribution and monitoring system for an LTA vehicle, includes: receiving a signal, by a first controller, indicting a failure in a second controller, wherein each of the first and the second controllers is coupled to a multiplexer in a crossbar architecture; inhibiting the second controller from controlling the multiplexer using the first controller; and directing power from a power source to an electronic component using the first controller to change the state of a power switch in the shared subsystem. In an example, the failure in the second controller comprises one or more of a memory corruption, a hardware fault, or an output of an erroneous value. In another example, the inhibiting the second controller from controlling the multiplexer using the first controller is performed autonomously. In another example, the inhibiting the second controller from controlling the multiplexer using the first controller is manually controlled. In another example, the method above, further includes: accessing a communications system using the first controller, wherein the communications system is located onboard the LTA vehicle; and monitoring the power source using the first controller. In another example, accessing the communications system comprises one or both of accessing a controller area network (CAN) bus and changing the state of an Ethernet switch. In another example, the crossbar architecture further comprises: a first control interface connection coupling the first controller to the multiplexer and a second control interface connection coupling the second controller to the multiplexer; a first control multiplexer select connection coupling the first controller to a first select switch and a second control multiplexer select connection coupling the second controller to a second select switch; a third control multiplexer select connection coupling the first select switch to the multiplexer and a fourth control multiplexer select connection coupling the second select switch to the multiplexer; and a first inhibiting connection coupling the first controller to the second select switch and a second inhibiting connection coupling the second controller to the first select switch.

### BRIEF DESCRIPTION OF THE DRAWINGS

FIG. 1 is a simplified schematic diagram of an example of a redundant controller system for a lighter than air (LTA) vehicle, in accordance with some embodiments.

FIGS. 2A and 2B are simplified schematic diagrams of examples of a redundant controller system for an LTA vehicle, in accordance with some embodiments.

FIGS. 3A-3B are diagrams of example LTA vehicle systems incorporating redundant controller systems, in accordance with some embodiments.

FIG. 4 is a flow diagram illustrating a method for controlling a power distribution and monitoring system for an LTA vehicle, in accordance with some embodiments.

FIG. 5 is a flow diagram illustrating a method for controlling a command and control system for an LTA vehicle, in accordance with some embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The invention is directed to a redundant controller system for power distribution and monitoring, command and control, or other subsystems, for lighter than air (LTA) vehicles. A redundant controller system (e.g., for controlling a power distribution and monitoring system, or a command and control system) can contain two (or more) controllers (e.g., flight controllers) in a crossbar style architecture. Each controller may be configured to receive instructions or commands through SATCOM (i.e., satellite communications system) or other communication channels. For example, in the case of a power distribution and monitoring system, the redundant controller system can direct power from a power source (or multiple power sources) to different subsystems within the LTA vehicle using a power distribution circuit. In the case of a command and control system, the redundant controller system can execute (or send) a command to components, or control components, of the LTA vehicle, for example, based on commands transmitted from a control system to the onboard redundant controller system. For example, any of the two or more controllers could be used to set/adjust a heater setpoint of a heater component in a system of the LTA vehicle. In another example, any of the two or more controllers (or more than one, or all) of the redundant control systems can actuate a flight termination system.

LTA vehicles with a single controller (e.g., a flight controller) controlling a central power distribution node and monitoring power systems, command and control systems, or other systems of the LTA vehicle are vulnerable if the single controller fails (e.g., becomes compromised, damaged or unable to communicate with other systems, for example the memory becomes corrupted or there is a hardware fault). Redundant controllers, for example that are each configured to control a central power distribution node and to monitor the power systems of an LTA vehicle, enable the LTA vehicle to continue to function (e.g., enable the power system to continue to function) if one of the controllers fails.

In some cases, the redundant controller system contains two or more redundant controllers, one or more of which has an independent communication network, such as a SATCOM network, a modem, and/or an antenna. For example, information for monitoring and controlling the LTA vehicles can be sent via a network when mesh backhaul is not available. Such information can include telemetry, command and control, and mesh backhaul bootstrapping. A mesh backhaul can include a connection between a mesh (e.g., a fleet of balloons) and backhaul (e.g., portions of the internet outside of the mesh, for example, including a secure data network (SDN), a telecommunications company, and/or an internet service provider (ISP)). When the mesh backhaul is not available (e.g., due to intermittent connectivity, variable latency or high latency of a SATCOM), then information for monitoring and controlling the LTA vehicles can be sent via an independent communication network (e.g., using a modem, an antenna, or a SATCOM that is not part of the mesh backhaul). Additionally, each controller can have access to relevant avionics networks (e.g., within the LTA vehicle and/or between the vehicle and an offboard system, for example in a ground station). For example, in the case of a power distribution and monitoring system, each controller can have access to avionics networks that are necessary to monitor energy source nodes (e.g., nodes for the batteries and/or solar panels), such that the power control and monitoring systems continue to work in case one controller fails.

In some cases, the two or more redundant controllers of the redundant controller system can be on the same controller area network (CAN) bus and/or can share a communication switch (e.g., an Ethernet switch) by use of a master-controller signal which can be toggled by either controller (e.g., until control is inhibited by the other).

The two or more controllers in redundant controller systems can also each be fully redundant. For example, in the case of a power distribution and monitoring system, each controller can have fully redundant power monitoring sensing using power monitors that are independent and/or shared between the two controllers.

The two or more controllers in redundant controller systems can also each have a switch architecture that allows a most recent action to override a previous action from the other controller including a way to fully inhibit the ability of one controller to perform actions by the other controller (and vice versa). Each redundant controller can inhibit the other, in some cases. In the case of a power distribution and monitoring system, for example, power switching topology for a particular switch can be such that both redundant controllers can use a muting system (e.g., wherein a first controller can inhibit a second redundant controller in a system with two controllers) or a voting system (e.g., wherein more than two controllers vote to determine whether to inhibit a controller in a system with more than two controllers) to override the other and toggle the switch. In some cases, if one controller fails then the other redundant controller can be configured to detect the failure (i.e., to receive a signal indicating that the other redundant controller has failed) and shut down the failed controller. A controller can be deemed to have failed (or be experiencing a failure) if it experiences any problem or irregularity (e.g., memory corruption, a hardware or other fault, outputs a threshold rate or amount of erroneous values, failure to report to other nodes in the system and/or to mission control, and other issues). The methods described above can be performed autonomously (e.g., via a watchdog scheme, either windowed or not) and/or can be manually (e.g., controlled by a flight engineer monitoring telemetry, for example, for the success of command and control operations). Methods similar to those described above can also be used to determine which redundant controller sends information over a CAN bus or is in control of an Ethernet switch.

In some cases, the redundant controller system can have a crossbar circuit architecture, where the two or more redundant controller nodes are coupled to a multiplexer, and the multiplexer is coupled to one or more systems of the LTA vehicle (e.g., power control and monitoring subsystems, or command and control subsystems). Such crossbar system architectures can enable either controller to communicate with and control the one or more systems of the LTA vehicle coupled to the multiplexer, and allow each redundant controller to inhibit the other.

The two or more controllers of the redundant controller system can be the same as (or similar to) one another, or different from one another. Additionally, the controllers can be in the same (or similar) locations, or different locations. For example, one of the redundant controllers can be more accurate and more susceptible to storms, while the another redundant controller can be less accurate but more hardened to storms. For example, one of the redundant controllers for power distribution and monitoring can be used that is more resilient (e.g., to electrical activity from storms) but has a larger error in estimating voltage and current signals (making it less accurate at deducing power, energy, and charge estimations of a power source) compared to another redundant controller. The other redundant controller can be less resilient, but can have smaller errors in estimating signals. Such differences in controller properties can be caused by, for example, a different controller shunt resistor, or a different controller power monitoring package. For example, one controller can have a power monitor with a 100 V rating, and the other controller can have a power monitor with a 150 V rating. The controller with the 150 V rated power monitor will be more likely to survive an electrical storm event (e.g., a lightning event) due to the higher rating, however, it will also be less accurate due to having a larger measurement range. In some cases, the properties of the two controllers can be chosen to optimize the tradeoff between the performance and the availability of the system.

The two or more controllers of the redundant controller system can be in the same physical enclosure, or in different physical enclosures. In some cases, the two redundant controllers can be electrically and/or physically isolated from one another, such that it is less likely that a single event (e.g., a lightning strike, or a physical impact) would damage both controllers.

In some cases, the two or more controllers of the redundant controller system configured in a crossbar architecture control a power distribution and monitoring system of an LTA vehicle. The power distribution and monitoring system can include one or more power sources (e.g., batteries, fuel cells, solar panels, and/or rotors or other blades configured to be spun by wind to generate energy), and electrical switches to direct power from a power source to an electrical component. The power distribution and monitoring system can control switches to direct power from a power source to an electrical component and monitor the power sources. Some parameters of a battery power source that can be monitored by a redundant controller system are temperatures, charge imbalance, faults, voltage, current, charge and energy accumulation, current state of charge, and parasitic power monitoring (e.g., including control and monitoring of heaters). Some parameters of a solar power source that can be monitored by a redundant controller system are parasitic power monitoring (e.g., including control and monitoring of heaters), temperature, faults, current, voltage, charge and energy accumulation, efficiency, and shading. The redundant controller system can also monitor voltage, current and power for different power distribution domains within the LTA vehicle. The electrical component powered by the power distribution and monitoring system can be any component onboard the LTA vehicle that requires electrical power, such as a flight computer, a communications component, an altitude control system component, a navigation system component, and a sensor.

In some cases, the two or more controllers of the redundant controller system configured in a crossbar architecture control a command and control system of an LTA vehicle. The command and control system can control components onboard the LTA vehicle, using feedback and/or input from systems onboard and/or offboard the LTA vehicle. The controllers controlling the command and control system can receive commands from offboard the LTA vehicle, and/or can be autonomous and not receive commands from offboard the LTA vehicle. The command and control system can be used to operate systems and components of the LTA vehicle, for example, an altitude control system, propulsion systems (e.g., a propeller), navigation components (e.g., actuated propellers and/or actuated control surfaces), heater setpoints, flight termination system actuation, gimbal pointing (e.g., using an actuation module to move a portion of the LTA vehicle), and other systems (e.g., using a sensor, communications array, etc.).

Example Systems

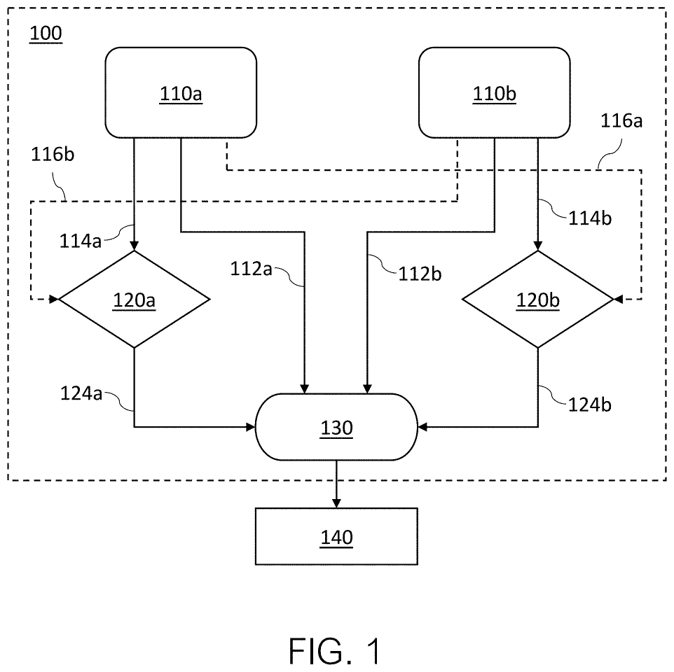

FIG. 1 is a simplified schematic diagram of an example of a redundant controller system for an LTA vehicle. The redundant controller system 100 includes two redundant controllers 110a and 110b in a crossbar architecture, where each controller 100a-b is coupled to multiplexer 130. The multiplexer 130 of the redundant controller system 100 is then coupled to a system 140 of the LTA vehicle through a control interface connection. The system 140 can be a power distribution and monitoring system, a command and control system, or another type of system, for an LTA vehicle. As such, in some cases, the components of the redundant controller system 100 are onboard an LTA vehicle.

Multiplexer 130 determines which controller 110a or 110b controls and/or senses components of system 140, based on input from both controllers 110a and 110b (through connections 124a and 124b). The electrical connections of the crossbar architecture include control interface connections 112a and 112b, control multiplexer select connections 114a and 114b and 124a and 124b, and inhibiting (or disabling) connections 116a and 116b. Connections 112a and 112b couple controllers 110a and 110b to multiplexer 130. Connections 114a and 114b couple controllers 110a and 110b to select switches 120a and 120b, which in turn are coupled to multiplexer 130 through connections 124a and 124b, respectively. Connections 116a and 116b couple the controllers 110a and 110b to the select switches 120b and 120a, respectively.

A “select switch” (e.g., 120a or 120b), as used herein, can be a mute switch with inputs for N controllers (e.g., 110a and 110b), where N is greater than or equal to 2, and where at most N−1 controllers (e.g., 110a or 110b) can be muted at a time. In other words, select switches 120a and 120b can enable at least one controller (e.g., 110a and 110b) to remain uninhibited by the other N−1 controllers (e.g., 110a or 110b) (i.e., degraded state operation), in some embodiments. Additionally, in some cases, it is possible for more than one controller or all controllers (e.g., 110a and 110b) to remain uninhibited by the select switches 120a and 120b (i.e., normal operation), and therefore for more than one controller (e.g., 110a and 110b) to communicate with the multiplexer 130 at the same time.

In operation, either controller 110a and 110b can interface with (e.g., control and/or sense components of) system 140. Furthermore, controller 110a can inhibit controller 110b through inhibiting connection 116a, and controller 110b can inhibit controller 110a through inhibiting connection 116b. Inhibiting connections 116a and 116b are not normally asserted. The selector switches 120a and 120b each take inputs from 110a and 110b through the control multiplexer select connections 114a and 114b and the inhibiting connections 116a and 116b, and determine which signals to send to the multiplexer 130 through control multiplexer select connections 124a and 124b. The signals provided to the multiplexer 130 through the control multiplexer select connections 124a and 124b direct the multiplexer 130 to couple one of the controllers 110a or 110b to the system 140.

The crossbar architecture of redundant controller system 100 enables controller 110a to inhibit control 110b, and vice versa. It also enables an action of controllers 110a and 110b to override a previous action from either controller. For example, each of the redundant controllers 110a and 110b can use a voting system to override the other and interface with system 140. In some cases, if one controller 110a or 110b fails (e.g., has memory corruption, a hardware fault, or outputs erroneous values) then the other redundant controller 110b or 110a, respectively, can be configured to detect the failure (i.e., to receive a signal indicating that the other redundant controller has failed) and shut down the failed controller 110a or 110b, respectively. The controllers 110a and 110b can inhibit or override one another using autonomous systems (e.g., via a watchdog scheme, either windowed or not) and/or using manually controlled systems (e.g., controlled by a flight engineer monitoring telemetry, for example, for the success of command and control operations).

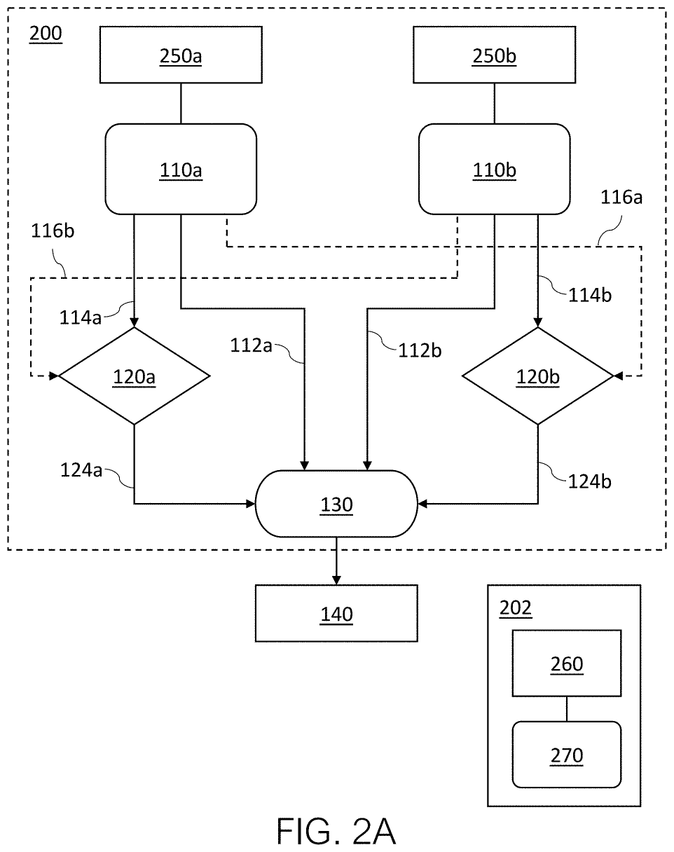

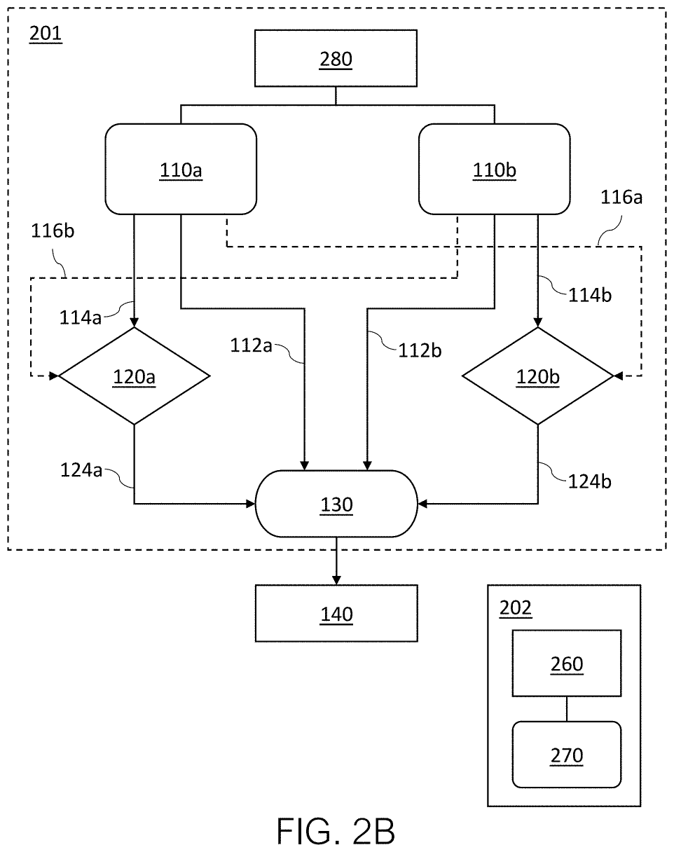

FIGS. 2A-2B are simplified schematic diagrams of other examples of a redundant controller system for an LTA vehicle. The redundant controller system 200 includes the same components of redundant controller system 100 in FIG. 1, and further includes a communications system comprising communications units 250a and 250b. Communications units 250a and 250b communicate with offboard system 202 located offboard the LTA vehicle (e.g., on the ground or in another aerial vehicle). Communications unit 250a is independently coupled to controller 110a, and communications unit 250b is independently coupled to controller 110b. The communications units 250a and 250b are configured to communicate with offboard communications unit 260, which is coupled to offboard system 270. Offboard system 270 can include additional processors, controllers, and components to enable manual monitoring (e.g., of telemetry by a flight engineer).

In FIG. 2B, the redundant controller system 201 includes many of the same components of redundant controller system 100 in FIG. 1 and offboard system 202 in FIG. 2A, and further includes a communications system 280. In this example, both controllers 110a and 110b of the redundant controller system 200 are coupled to communications system 280, and the communications system 280 is shared between the two controllers 110a and 110b. For example, both controllers 110a and 110b of the redundant controller system 200 can be on the same controller area network (CAN) bus and/or can share a communication switch (e.g., an Ethernet switch) by use of a master-controller signal which can be toggled by either controller (e.g., until control is inhibited by the other). In such cases, a single communications unit (not shown) can be coupled to a switch that is coupled to both controllers 110a and 110b, allowing the single communications unit to be shared between the controllers 110a and 110b.

In other cases, the redundant controller system can contain more than two redundant controllers arranged in a crossbar architecture similar to the crossbar architectures shown in system 100 in FIG. 1, system 200 in FIG. 2A, and/or system 201 in FIG. 2B. In such cases, each of the redundant controllers can have the ability to inhibit any of the other redundant controllers in the redundant controller system. This can be accomplished, for example, by including additional select switches and additional inhibition connections. For example, the redundant controller system can include a select switch for each of the two or more redundant controllers (e.g., the select switch having an input for each redundant controller), wherein each redundant controller is coupled to a select switch via control multiplexer select connections (e.g., similar to 114a and 114b in FIG. 1). The inhibiting connections (e.g., similar to 116a and 116b in FIG. 1) can then be coupled from each redundant controller to multiple additional inputs of each select switch, thereby providing each redundant controller the ability to inhibit any of the other redundant controllers in the redundant controller system.

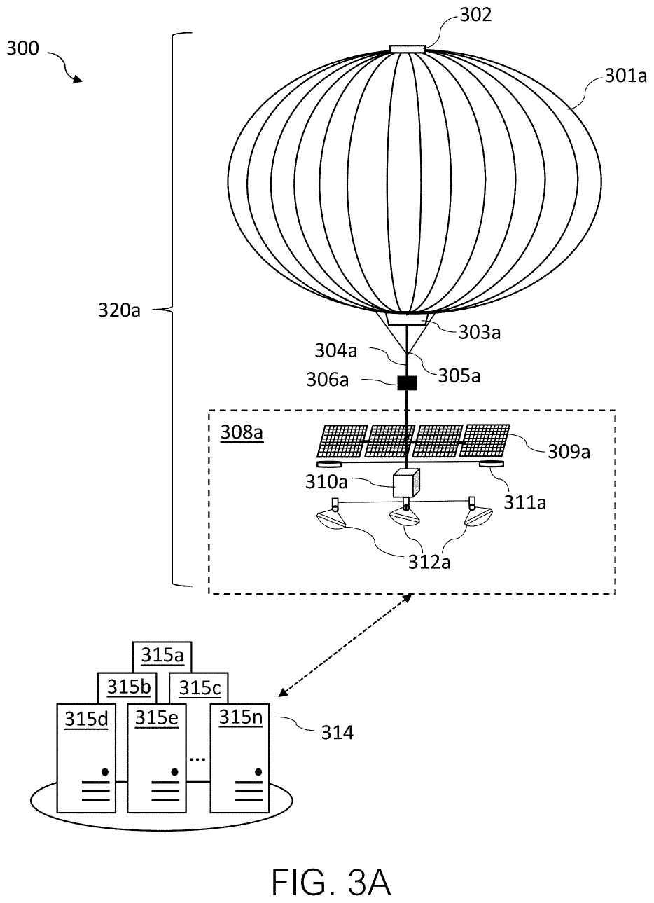

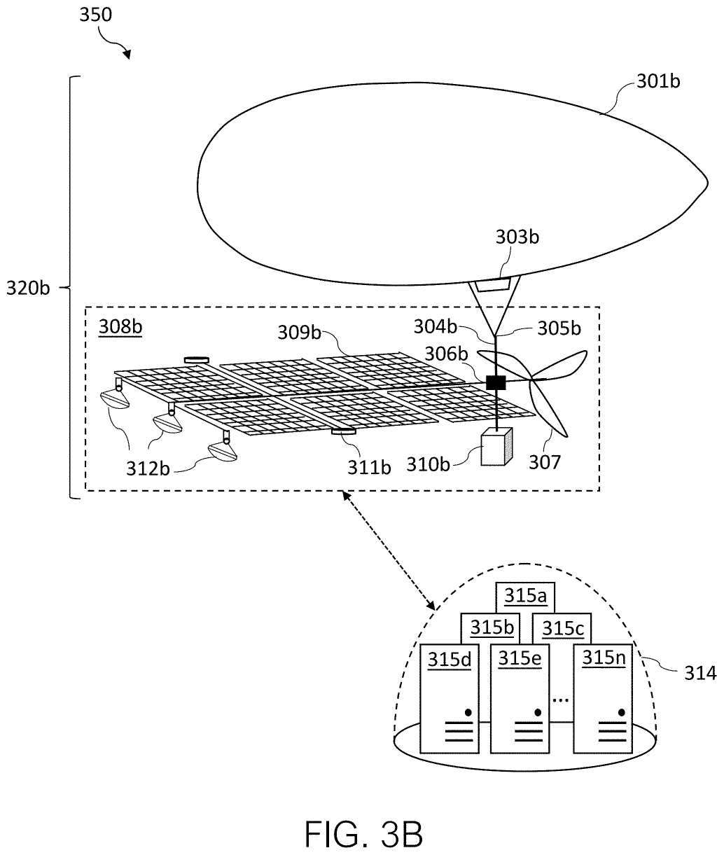

FIGS. 3A-3B are diagrams of example LTA vehicle systems incorporating redundant controller systems, in accordance with some embodiments. The LTA vehicles 320a-b shown in FIGS. 3A-3B, and described further below, may contain redundant controllers coupled to one or more systems of the LTA vehicle using a crossbars architecture, as described above.

In FIG. 3A, there is shown a diagram of system 300 for control and/or navigation of LTA vehicle 320a. In some examples, LTA vehicle 320a may be a passive vehicle, such as a balloon or satellite, wherein most of its directional movement is a result of environmental forces, such as wind and gravity. In other examples, LTA vehicles 320a may be actively propelled. In an embodiment, system 300 may include LTA vehicle 320a and ground station 314. In this embodiment, LTA vehicle 320a may include balloon 301a, plate 302, altitude control system (ACS) 303a, connection 304a, joint 305a, actuation module 306a, and payload 308a. In some examples, plate 302 may provide structural and electrical connections and infrastructure. Plate 302 may be positioned at the apex of balloon 301a and may serve to couple together various parts of balloon 301a. In other examples, plate 302 also may include a flight termination unit (e.g., that is a part of a flight termination system), such as one or more blades and an actuator to selectively cut a portion and/or a layer of balloon 301a. ACS 303a may include structural and electrical connections and infrastructure, including components (e.g., fans, valves, actuators, etc.) used to, for example, add and remove air from balloon 301a (i.e., in some examples, balloon 301a may include an interior ballonet within its outer, more rigid shell that is inflated and deflated), causing balloon 301a to ascend or descend, for example, to catch stratospheric winds to move in a desired direction. Balloon 301a may comprise a balloon envelope comprised of lightweight and/or flexible latex or rubber materials (e.g., polyethylene, polyethylene terephthalate, chloroprene), tendons (e.g., attached at one end to plate 302 and at another end to ACS 303a) to provide strength to the balloon structure, a ballonet, along with other structural components. In various embodiments, balloon 301a may be non-rigid, semi-rigid, or rigid.

Connection (i.e., down-connect) 304a may structurally, electrically, and communicatively, connect balloon 301a and/or ACS 303a to various components comprising payload 308a. In some examples, connection 304a may provide two-way communication and electrical connections, and even two-way power connections. Connection 304a may include a joint 305a, configured to allow the portion above joint 305a to pivot about one or more axes (e.g., allowing either balloon 301a or payload 308a to tilt and turn). Actuation module 306a may provide a means to actively turn payload 308a for various purposes, such as improved aerodynamics, facing or tilting solar panel(s) 309a advantageously, directing payload 308a and propulsion units (e.g., propellers 307 in FIG. 3B) for propelled flight, or directing components of payload 308a advantageously.

Payload 308a may include solar panel(s) 309a, avionics chassis 310a, broadband communications unit(s) 311a, and terminal(s) 312a. Solar panel(s) 309a may be configured to capture solar energy to be provided to a battery or other energy storage unit, for example, housed within avionics chassis 310a. Avionics chassis 310a also may house a flight computer (e.g., to electronically control various systems within the LTA vehicle 320a), a transponder, along with other control and communications infrastructure (e.g., a computing device and/or logic circuit configured to control LTA vehicle 320a). In some cases, the flight computer comprises one or both of the controllers (e.g., 110a and/or 110b in FIGS. 1, 2A and 2B), as described herein. Communications unit(s) 311a may include hardware to provide wireless network access (e.g., LTE, fixed wireless broadband via 5G, Internet of Things (IoT) network, free space optical network or other broadband networks). Communications unit(s) 311a can be one or both of communications units 250a and 250b in FIG. 2A. Terminal(s) 312a may comprise one or more parabolic reflectors (e.g., dishes) coupled to an antenna and a gimbal or pivot mechanism (e.g., including an actuator comprising a motor). Terminal(s) 312a may be configured to receive or transmit radio waves to beam data long distances (e.g., using the millimeter wave spectrum or higher frequency radio signals). In some examples, terminal(s) 312a may have very high bandwidth capabilities. Terminal(s) 312a also may be configured to have a large range of pivot motion for precise pointing performance Terminal(s) 312a also may be made of lightweight materials.

The redundant controller system (e.g., 100 in FIG. 1, or 200 in FIG. 2A) (not shown) can be coupled to any part of the LTA vehicle 320a, such as any part of the payload 308a, the chassis 310a, the actuation module 306a, the down-connect 304a, or the apex plate 302. The LTA vehicle system (e.g., 140 in FIGS. 1, 2A and 2B) controlled by the redundant controller system can be coupled to any part of the LTA vehicle 320a, for example, any part of the payload 308a, the chassis 310a, the down-connect 304a, the ACS 303a, or the apex plate 302. In some cases, the LTA vehicle system is a power distribution and monitoring system coupled to the solar panels 309a, and/or to a battery or other energy storage unit, for example, housed within avionics chassis 310a. In some cases, the LTA vehicle system is a command and control system coupled to the flight computer (e.g., housed in avionics chassis 310a).

In other examples, payload 308a may include fewer or more components, including propellers 307 as shown in FIG. 3B, which may be configured to propel LTA vehicles 320a-b in a given direction. In still other examples, payload 308a may include still other components well known in the art to be beneficial to flight capabilities of an LTA vehicle. For example, payload 308a also may include energy capturing units apart from solar panel(s) 309a (e.g., rotors or other blades (not shown) configured to be spun by wind to generate energy). In another example, payload 308a may further include or be coupled to an imaging device (e.g., a star tracker, IR, video, Lidar, and other imaging devices, for example, to provide image-related state data of a balloon envelope, airship hull, and other parts of an LTA vehicle). In another example, payload 308a also may include various sensors (not shown), for example, housed within avionics chassis 310a or otherwise coupled to connection 304a or balloon 301a. Such sensors may include Global Positioning System (GPS) sensors, wind speed and direction sensors such as wind vanes and anemometers, temperature sensors such as thermometers and resistance temperature detectors, speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors, and more. These examples of sensors are not intended to be limiting, and those skilled in the art will appreciate that other sensors or combinations of sensors in addition to these described may be included without departing from the scope of the present disclosure.

Ground station 314 may include one or more server computing devices 315a-n, which in turn may comprise one or more computing devices (e.g., a computing device and/or logic circuit configured to control LTA vehicle 320a). In some examples, ground station 314 also may include one or more storage systems, either housed within server computing devices 315a-n, or separately. Ground station 314 may be a datacenter servicing various nodes of one or more networks. Ground station 314 can also include a communications unit (not shown) to transmit and receive signals to and from LTA vehicle 320a.

In some cases, the redundant controller system (e.g., 100 in FIG. 1, or 200 in FIG. 2A) includes communications units (e.g., 250a and 250b in FIG. 2A) onboard the LTA vehicle, such as communications unit(s) 311a. The onboard communications unit(s) 311a can communicate with an offboard system (e.g., 202 in FIG. 2A), for example, ground station 314 containing a communications unit (e.g., 260 in FIG. 2A).

FIG. 3B shows a diagram of system 350 for control and/or navigation of LTA vehicle 320b. All like-numbered elements in FIG. 3B are the same or similar to their corresponding elements in FIG. 3A, as described above (e.g., balloon 301a and balloon 301b may serve the same function, and may operate the same as, or similar to, each other). In some examples, balloon 301b may comprise an airship hull or dirigible balloon. In this embodiment, LTA vehicle 320b further includes, as part of payload 308b, propellers 307, which may be configured to actively propel LTA vehicle 320b in a desired direction, either with or against a wind force to speed up, slow down, or re-direct, LTA vehicle 320b. In this embodiment, balloon 301b also may be shaped differently from balloon 301a, to provide different aerodynamic properties.

As shown in FIGS. 3A-3B, LTA vehicles 320a-b may be largely wind-influenced LTA vehicle, for example, balloons carrying a payload (with or without propulsion capabilities) as shown, or fixed wing high altitude drones (not shown) with gliding and/or full propulsion capabilities. However, those skilled in the art will recognize that the systems disclosed herein may similarly apply and be usable by various other types of LTA vehicles.

Example Methods

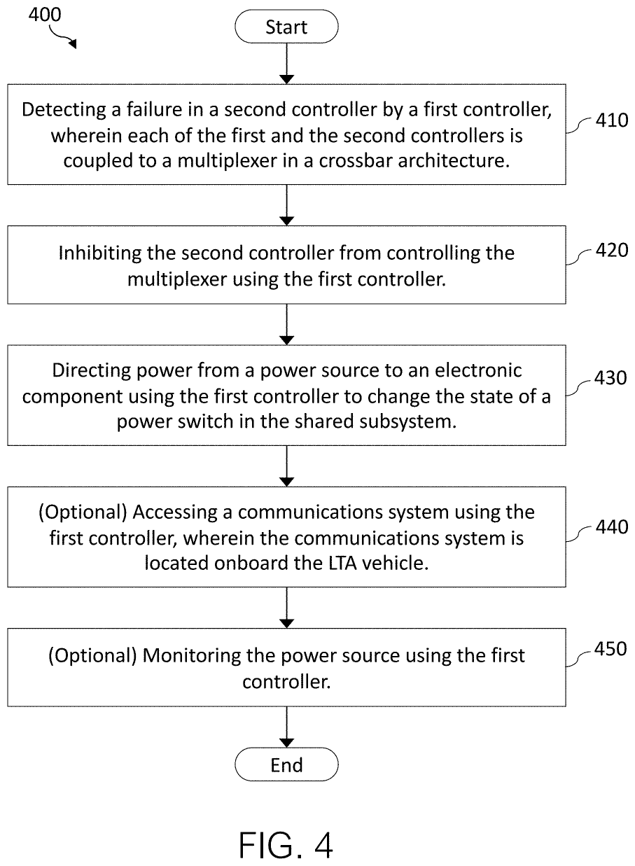

FIG. 4 is a flow diagram illustrating a method 400 for controlling a power distribution and monitoring system for an LTA vehicle. Method 400 can be performed using the redundant controller systems described herein (e.g., system 100 in FIG. 1, system 200 in FIG. 2A, or system 201 in FIG. 2B). In step 410, a failure in a second controller is detected by a first controller, where each of the first and the second controllers is coupled to a multiplexer in a crossbar architecture. In step 420, the second controller is inhibited from controlling the multiplexer using the first controller. The inhibiting can be performed using any of the methods described herein. For example, the inhibiting can be performed autonomously (e.g., via a watchdog scheme, either windowed or not) and/or manually (e.g., controlled by a flight engineer monitoring telemetry, for example, for the success of command and control operations). In step 430, power is directed from a power source to an electronic component using the first controller. For example, the first controller can change the state of a power switch in the shared subsystem to direct power from the power source to the electronic component.

Method 400 can also optionally include step 440, wherein a communications system is accessed using the first controller. The communications system is located onboard the LTA vehicle, and can be used to communicate with other systems onboard the LTA vehicle and/or to communicate with systems offboard the LTA vehicle (e.g., systems located in a ground station, such as 314 in FIGS. 3A and 3B). Additionally, method 400 can optionally include step 450, wherein the power source is monitored using the first controller. The power sources can be batteries, fuel cells, solar panels, and/or rotors or other blades configured to be spun by wind to generate energy, and electrical switches can be used to direct power from the power source to an electrical component. Some parameters of a battery power source that can be monitored by a redundant controller system are temperatures, charge imbalance, faults, voltage, current, charge and energy accumulation, current state of charge, and parasitic power monitoring (e.g., including control and monitoring of heaters). Some parameters of a solar power source that can be monitored by a redundant controller system are parasitic power monitoring (e.g., including control and monitoring of heaters), temperature, faults, current, voltage, charge and energy accumulation, efficiency, and shading. The redundant controller system can also monitor voltage, current and power for different power distribution domains within the LTA vehicle.

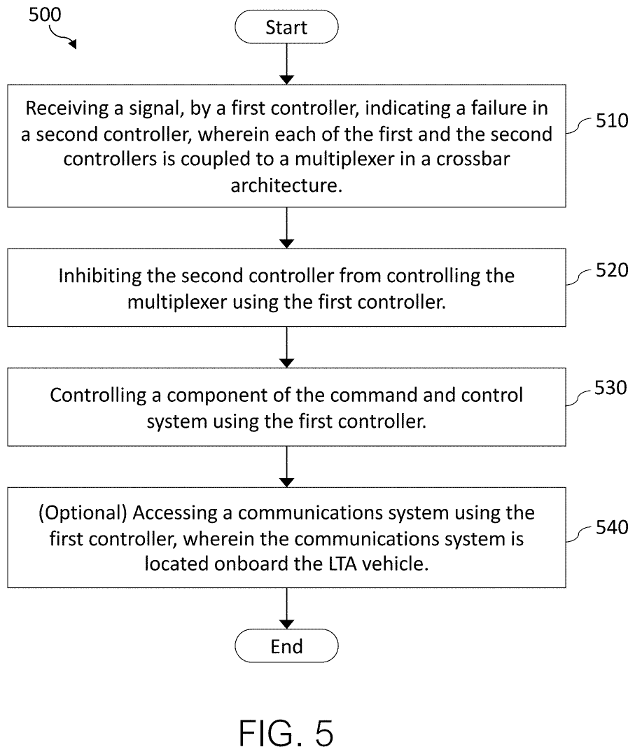

FIG. 5 is a flow diagram illustrating a method 500 for controlling a command and control system for an LTA vehicle. Method 500 can be performed using the redundant controller systems described herein (e.g., system 100 in FIG. 1, system 200 in FIG. 2A, or system 201 in FIG. 2B). In step 510, a first controller receives a signal indicating a failure in a second controller, where each of the first and the second controllers is coupled to a multiplexer in a crossbar architecture. In step 520, the second controller is inhibited from controlling the multiplexer using the first controller. The inhibiting can be performed using any of the methods described herein. For example, the inhibiting can be performed autonomously (e.g., via a watchdog scheme, either windowed or not) and/or can be manually (e.g., controlled by a flight engineer monitoring telemetry, for example, for the success of command and control operations). In step 530, a component of the command and control system is controlled using the first controller (as described herein). For example, the first controller can control a component onboard the LTA vehicle, using feedback and/or input from a system onboard and/or offboard the LTA vehicle. The component can be an electrical component powered by the power distribution and monitoring system can be any component onboard the LTA vehicle that requires electrical power, such as a flight computer, a communications component, an altitude control system component, a navigation system component, and a sensor. Method 500 can also optionally include step 540, wherein a communications system is accessed using the first controller. The communications system is located onboard the LTA vehicle, and can be used to communicate with other systems onboard the LTA vehicle and/or to communicate with systems offboard the LTA vehicle (e.g., systems located in a ground station, such as 314 in FIGS. 3A and 3B).

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements.

What is claimed is:

1. A power distribution and monitoring system for a lighter than air vehicle, comprising:
two or more redundant controllers coupled to a multiplexer in a crossbar architecture, wherein each controller is configured to control the multiplexer and to inhibit the other controller in the case of a failure of the other controller;
a shared subsystem coupled to the multiplexer, the shared subsystem comprising a power switch;
a power source coupled to the shared subsystem; and
an electronic component coupled to the shared subsystem,
wherein each of the two or more redundant controllers is further configured to control the power switch to direct power from the power source to the electronic component,
wherein each of the two or more redundant controllers is further configured to monitor the power source.

2. The power distribution and monitoring system of claim 1, further comprising two or more select switches that are coupled to the two or more redundant controllers and to the multiplexer, wherein the crossbar architecture comprises two or more control interface connections between each of the two or more redundant controllers and the multiplexer, two or more control multiplexer select connections between each of the two or more redundant controllers and the multiplexer, and two or more inhibiting connections between each of the two or more redundant controllers and two or more select switches.

3. The power distribution and monitoring system of claim 2, wherein one of the two or more control multiplexer select connections is output from each of the two or more redundant controllers and input into one of the two or more select switches, and one of the two or more control multiplexer select connections is output from each of the two or more select switches and input into the multiplexer.

4. The power distribution and monitoring system of claim 1, wherein the two or more redundant controllers comprise a first and a second controller, and wherein the crossbar architecture further comprises:
a first control interface connection coupling the first controller to the multiplexer and a second control interface connection coupling the second controller to the multiplexer;
a first control multiplexer select connection coupling the first controller to a first select switch and a second control multiplexer select connection coupling the second controller to a second select switch;
a third control multiplexer select connection coupling the first select switch to the multiplexer and a fourth control multiplexer select connection coupling the second select switch to the multiplexer; and
a first inhibiting connection coupling the first controller to the second select switch and a second inhibiting connection coupling the second controller to the first select switch.

5. The power distribution and monitoring system of claim 1, wherein the two redundant controllers are located in the same physical enclosure and are electrically isolated from one another.

6. The power distribution and monitoring system of claim 1, wherein the power source comprises one or more of a battery, a fuel cell, a solar panel, and rotors configured to be spun by wind to generate energy.

7. The power distribution and monitoring system of claim 6, wherein the two or more redundant controllers is further configured to monitor one or more parameters of the power source, wherein the one or more parameters of the power source comprise one or more of a temperature, a charge imbalance, a fault, a voltage, a current, charge accumulation, energy accumulation, a current state of charge, efficiency, shading, and parasitic power monitoring.

8. The power distribution and monitoring system of claim 1, wherein the electronic component comprises one or more of a flight computer, a communications component, an altitude control system component, a navigation system component, and a sensor.

9. The power distribution and monitoring system of claim 1, further comprising a communications system coupled to the two redundant controllers, wherein the communications system comprises two or more communications units, each communications unit coupled to one of the two or more redundant controllers.

10. The power distribution and monitoring system of claim 1, further comprising a communications system coupled to the two or more redundant controllers, wherein the communications system is shared by the two or more redundant controllers.

11. The power distribution and monitoring system of claim 1, wherein the shared subsystem further comprises a communications system, and wherein the two or more redundant controllers control the communications system.

12. A method for controlling a power distribution and monitoring system for a lighter than air (LTA) vehicle, comprising:
receiving a signal, by a first controller, indicting a failure in a second controller, wherein each of the first and the second controllers is coupled to a multiplexer in a crossbar architecture;
inhibiting the second controller from controlling the multiplexer using the first controller; and
directing power from a power source to an electronic component using the first controller to change the state of a power switch in the shared subsystem.

13. The method of claim 12, wherein the failure in the second controller comprises one or more of a memory corruption, a hardware fault, or an output of an erroneous value.

14. The method of claim 12, wherein the inhibiting the second controller from controlling the multiplexer using the first controller is performed autonomously.

15. The method of claim 12, wherein the inhibiting the second controller from controlling the multiplexer using the first controller is manually controlled.

16. The method of claim 12, further comprising:
accessing a communications system using the first controller, wherein the communications system is located onboard the LTA vehicle; and
monitoring the power source using the first controller.

17. The method of claim 16, wherein accessing the communications system comprises one or both of accessing a controller area network (CAN) bus and changing the state of an Ethernet switch.

18. The method of claim 12, wherein the crossbar architecture further comprises:
a first control interface connection coupling the first controller to the multiplexer and a second control interface connection coupling the second controller to the multiplexer;
a first control multiplexer select connection coupling the first controller to a first select switch and a second control multiplexer select connection coupling the second controller to a second select switch;
a third control multiplexer select connection coupling the first select switch to the multiplexer and a fourth control multiplexer select connection coupling the second select switch to the multiplexer; and
a first inhibiting connection coupling the first controller to the second select switch and a second inhibiting connection coupling the second controller to the first select switch.
